(19) United States
(12) Patent Application Publication
(10) Pub. No.: US 2007/0222622 A1
(43) Pub. Date: Sep. 27, 2007

(54) Child safety seat alert system

(76) Inventor: Janetta Sweeney, Loma Linda, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/386,435

(22) Filed: Mar. 22, 2006

(51) Int. Cl. G08B 23/00; G08B 21/00

(52) U.S. Cl. 340/573.1; 340/686.6

(57) ABSTRACT

A system for alerting someone that a child is in a safety seat in a vehicle includes a proximity sensor/transmitter and a receiver. The receiver is removably mounted on a child's car seat and the proximity sensor/transmitter remains on the car seat. After a child is placed in the seat, the receiver is removed from the seat and placed on the driver or other adult responsible for the child. The receiver can be placed in the person's purse or on their person. If the person moves away from the vehicle without disabling the transmitter on the car seat will activate that receiver as soon as the receiver has moved a prescribed distance away from the vehicle. The receiver will generate a signal, such as an audible and/or visible signal, which will attract the attention of the person carrying the receiver. The signal will be generated in a continuous manner until the transmitter is disabled, which can only be done after the child is removed from the seat. The system further includes a light on the transmitter that is activated when the receiver is removed from the seat to signal that the system is active.

### TECHNICAL FIELD OF THE INVENTION

The present invention is directed in general to vehicle safety accessories and, more particularly, to safety accessories associated with children and infants.

### BACKGROUND OF THE INVENTION

Children frequently fall asleep when being transported in vehicles. As a result, it is possible for a driver to forget that they are transporting a child if the baby remains quiet for a long period of time. Forgetting a child inside of a vehicle can result in severe injury to or the death of the child from extreme temperature conditions and/or dehydration. To increase the safety of a child within a car, safety devices such as car seats have been developed. However, each of the known safety devices is designed to increase a child's safety while the automobile is moving, i.e., during automobile operation. Such devices do not prevent a child from inadvertently being locked in a parked automobile. Therefore, there is a need for a system that will alert a driver or other adult that a child is in the vehicle so the driver or adult will not leave the child in the vehicle.

While the inventor is aware of several systems that will alert someone that a child is in a safety seat, the inventor has noted several problems with these known systems. For example, some systems are very complex and hence are expensive and difficult to maintain and susceptible to problems. Still other systems will only alert the adult in the immediate vicinity of the vehicle. If the adult is distracted while he or she is in the immediate vicinity of the vehicle, such as if they are loading or unloading the vehicle, talking on a cell phone, or performing a task that is out of his or her normal routine, the alarm may not register with that person.

The inventor has observed that after performing a task, such as loading or unloading a vehicle, and then walking away from the vehicle, a person will be very receptive to an alert and such an alert is quite likely to register and trigger the proper response in the person.

Therefore, there is a need for a system that will alert a driver or other adult that a child is in the vehicle so the driver or adult will not leave the child in the vehicle and will alert the adult in a manner that is likely to register with the adult.

### SUMMARY OF THE INVENTION

These, and other, objects are achieved by a system for alerting someone that a child remains in a vehicle. The system embodying the present invention alerts the person of the child's continued presence in the vehicle in a manner that is likely to attract the person's attention and in a manner that is most likely to register with the person, even if that person is otherwise distracted.

The system embodying the present invention includes a proximity sensor/transmitter and a receiver. The receiver is removably mounted on a child's car seat and the proximity sensor/transmitter remains on the car seat. After a child is placed in the seat, the receiver is removed from the seat and placed on the driver or other adult responsible for the child. The receiver can be placed in the person's purse or on their person. If the person moves away from the vehicle without disabling the transmitter on the car seat will activate that receiver as soon as the receiver has moved a prescribed distance away from the vehicle. The receiver will generate a signal, such as an audible and/or visible signal, which will attract the attention of the person carrying the receiver. The signal will be generated in a continuous manner until the transmitter is disabled, which can only be done after the child is removed from the seat. The system further includes a light on the transmitter that is activated when the receiver is removed from the seat to signal that the system is active.

In this manner, a person is alerted in a manner that is likely to attract and retain their attention because they are not distracted by an immediate task associated with the vehicle and are likely to be, at least subconsciously, aware that the child has been left in the vehicle, in which case the signal from the receiver is quite likely to register with the person and help them recall that the child has not been removed from the car seat.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a child safety seat having a system for alerting someone that a child remains in the seat embodying the present invention.

FIG. 2 is a detail view of a proximity transmitter on the seat and which is included in the system embodying the present invention.

FIG. 3 illustrates the operation of the system embodying the present invention.

FIG. 4 is a schematic illustrating the system embodying the present invention.

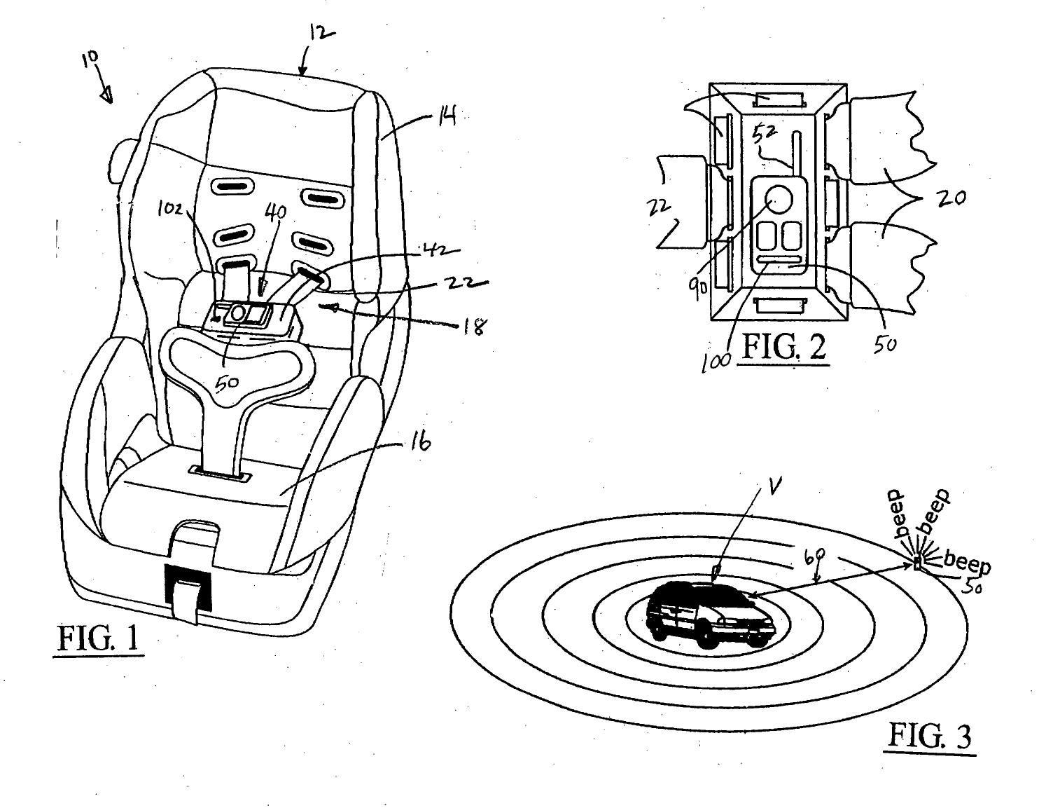

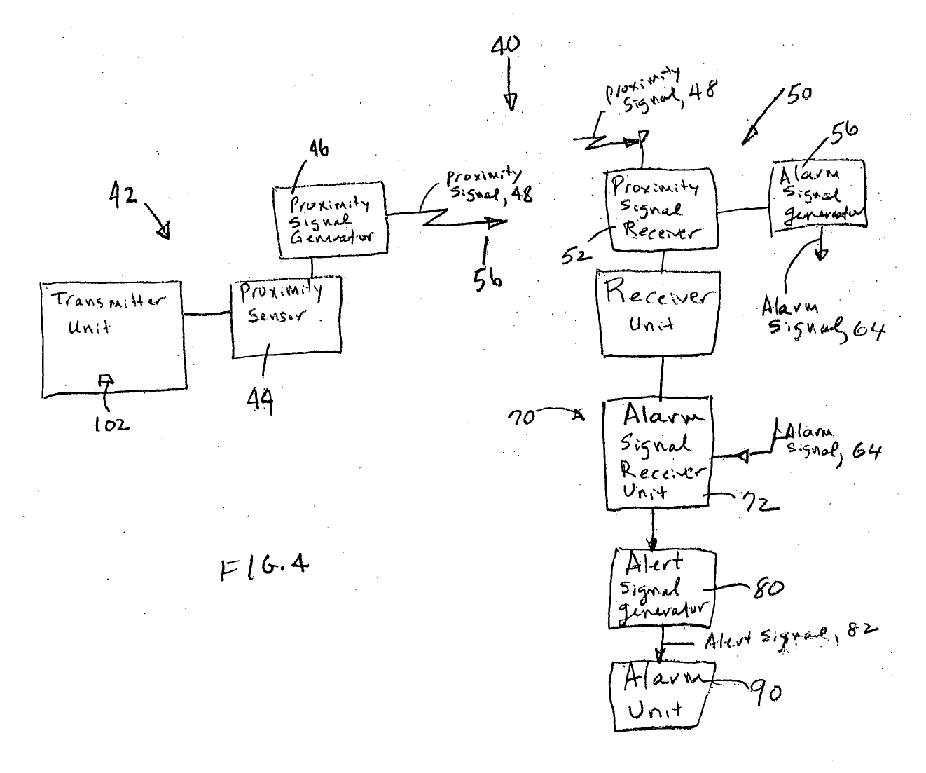

### DETAILED DESCRIPTION OF THE INVENTION

Referring to the figures, it can be understood that the present invention is embodied in a system 10 for alerting someone that a child is in a safety seat in a vehicle in a manner that is likely to capture the individual's attention.

System 10 comprises a safety seat 12 for use by a child or infant in a motor vehicle, such as an automobile V. The seat includes a back supporting section 14, a seat section 16, and a seat belt system 18. Seat belt system 18 includes seat belts which fit around a child when the child is strapped into the seat as is the case with common child safety seats. It is noted that seat 12 is of the type commonly known in the art. The seat belts include shoulder belts 20 and belts 22 that fit between the child's legs.

A signaling system 40 is used to alert an individual that a child is in seat 12. System 40 includes a transmitter unit 42 that is fixedly mounted on the safety seat. As best indicated in FIG. 4, transmitter unit 42 includes a proximity sensor 44 which includes a proximity signal generator 46 which generates a proximity signal 48 when the transmitter unit is activated. The proximity sensor can be mounted on the seat or on the seat belt.

System 40 further includes a receiver unit 50 that is removably mounted on the safety seat in a position that will be covered by the child when the child is accommodated in the safety seat. This location will require that in order for the child or infant to be comfortably accommodated in the seat, a person in charge of the child must remove the receiver prior to placing the child in the seat. This requirement will ensure that the receiver is used. The receiver unit includes a proximity signal receiver 52 that is connected to the proximity signal generator of the transmitter unit via an over-the-air connection 56 to receive the proximity signal 48 generated by proximity signal generator 46. Proximity signal receiver 52 includes an alarm signal generator 56 which is activated when the proximity signal receiver has moved away from the proximity sensor in the safety seat a preset distance 60. Alarm signal generator 56 generates an alarm signal 64 when activated.

An alarm system 70 includes an alarm signal receiver unit 72 which is included in the receiver unit and is connected to alarm signal generator 56 to receive alarm signal 64 from the alarm signal generator. The connection can be hard wired or over-the-air. An alert signal generator 80 is connected to alarm signal receiver unit 72 to generate an alert signal 82 in response to the alarm signal received by the alert signal generator. An alarm element 90 is located in the receiver unit and is connected to alert signal generator 80 to be activated when alert signal 82 is received by the alarm element from the alert signal generator.

It is noted that the alarms, the proximity elements, the receivers, the generators and the like can all be suitable circuits known to those skilled in the art. Such circuits can be designed by those skilled in the electronics art based on the teaching of this disclosure, and the exact nature of the circuits is not important to the present invention. Therefore, the exact circuitry required to carry out this invention will not be disclosed here.

An indicator light 100 is also located on the receiver unit and is activated when that receiver unit is removed from the seat to notify a user that the system is active. A manual switch 102 is located on the seat belt system to manually de-activate system 10 after the child has been removed from the seat. The manual switch is located to be covered by the child when that child is in the seat so that the manual switch cannot be accessed unless the child has been removed from the seat. Switch 102 is automatically re-set to activate the system whenever a child is placed in the seat. Alternatively, switch 102 can be on the receiver unit to activate that unit when the receiver unit is removed from the seat and to de-activate the unit when the unit is replaced on the seat.

Use of system 10 can be understood from the teaching of the foregoing disclosure and thus will only be briefly presented. A child is strapped into seat 12 after receiver unit 50 is removed and activated by the removal. A switch in the receiver unit connects that unit to the power system of the vehicle so that upon removal of the receiver unit from the seat, the indicator light will be activated as the system is activated by such removal. The user then keeps the receiver unit on his or her person. If the person moves away from the vehicle without removing the child from the seat, proximity sensor 46 will activate alarm unit 90, which is usually an audible alarm, but can also be a visible alarm as well, as soon as the person has moved away from the vehicle preset distance 60. Once the child has been removed from the seat, manual switch 102 can be operated to shut down system 10.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A system for alerting someone that a child is in a safety seat in a vehicle comprising:
A) a safety seat for use by a child or infant in a motor vehicle, such as an automobile, the seat including a back supporting section, a seat section, and a seat belt system which includes seat belts which fit around a child when the child is strapped into the seat, the seat belts including shoulder belts and belts that fit between the child's legs; and
B) a signaling system which includes
(1) a transmitter unit that is fixedly mounted on the safety seat, the transmitter unit including a proximity sensor, the proximity sensor including a proximity signal generator which generates a proximity signal when the transmitter unit is activated,
(2) a receiver unit that is removably mounted on the safety seat in a position that will be covered by the child or infant when the child or infant is accommodated in the safety seat, the position being such that the receiver unit must be removed in order for the child or infant to be comfortably accommodated in the safety seat, the receiver unit including a proximity signal receiver that is connected to the proximity signal generator of the transmitter unit via an over-the-air connection to receive the proximity signal generated by the proximity signal generator of the proximity sensor of the transmitter unit, the proximity signal receiver including an alarm signal generator which is activated when the proximity signal receiver of the receiver unit has moved away from the proximity sensor in the safety seat a preset distance, the alarm signal generator generating an alarm signal when activated, and
(3) an alarm system which includes
(a) an alarm signal receiver unit included in the receiver unit and connected to the alarm signal generator of receiver unit to receive the alarm signal from the alarm signal generator, and
(b) an alert signal generator connected to the alarm signal receiver unit of the receiver unit to generate an alert signal in response to the alarm signal received by the alert signal generator, and
(c) an alarm element in the receiver unit and connected to the alert signal generator of the alarm system to be activated when an alert signal is received by the alarm element from the alert signal generator.

2. The system defined in claim 1 further including a manually operated on/off switch.

3. A system for alerting someone that a child is in a safety seat in a vehicle comprising:
A) a safety seat for use by a child or infant when that child or infant is in a motor vehicle, such as an automobile; and
B) a signaling system which includes
(1) a transmitter unit that is fixedly mounted on the safety seat, the transmitter unit including a proximity sensor, the proximity sensor including a proximity signal generator which generates a proximity signal when the transmitter unit is activated,
(2) a receiver unit that is removably mounted on the safety seat in a position that will be covered by the child or infant when the child or infant is accommodated in the safety seat, the position being such that the receiver unit must be removed from the safety seat in order for the child or infant to be comfortably accommodated in the safety seat, the receiver unit including a proximity signal receiver that is connected to the proximity signal generator of the transmitter unit via an over-the-air connection to receive the proximity signal generated by the proximity signal generator of the proximity sensor of the transmitter unit, the proximity signal receiver including an alarm signal generator which is activated when the proximity signal receiver of the receiver unit has moved away from the proximity sensor in the safety seat a preset distance, the alarm signal generator generating an alarm signal when activated,
(3) an alarm system which includes
(a) an alarm signal receiver unit included in the receiver unit and connected to the alarm signal generator of receiver unit to receive the alarm signal from the alarm signal generator and to an alert signal in response to the alarm signal received by the alert signal generator, and
(b) an alarm element in the receiver unit and connected to the alarm signal receiver to be activated when an alert signal is received by the alarm element, and
(4) an indicator light on the receiver unit.

4. A system for alerting someone that a child is in a safety seat in a vehicle comprising:
A) a safety seat in which a child or infant sits when the child or infant is in a motor vehicle, such as an automobile;
B) a proximity sensor system which includes
(1) a first element fixed to the safety seat,
(2) a second element which is movable with respect to the first element, the second element being removably mounted on the safety seat in a location that will be covered by a child when that child is in the safety seat with the location being such that the second element must be removed from the safety seat for the child to be comfortably placed in the safety seat, and
(3) an alarm signal generator in the second element which is activated to generate an alarm signal when the second element moves away from the first element more than a prescribed distance;
B) an alarm system which includes an alarm generator which is connected to the alarm signal generator of the proximity sensor system to be activated in response to an alarm signal generated by the alarm signal generator; and
C) an on/off switch connected to the second element of the proximity sensor system which activates the proximity sensor system and the alarm system when the second element is removed from the safety seat and which deactivates the proximity sensor system and the alarm system when the second element is mounted on the safety seat.
